(19) United States
(12) Patent Application Publication
(10) Pub. No.: US 2013/0015665 A1
(43) Pub. Date: Jan. 17, 2013

(54) WIND TURBINE COOLING ARRANGEMENT

(71) Applicant: ALEX YUNDONG WANG, Herning (DK)

(72) Inventor: ALEX YUNDONG WANG, Herning (DK)

(21) Appl. No.: 13/534,398

(22) Filed: Jun. 27, 2012

(30) Foreign Application Priority Data
Jul. 14, 2011 (EP) EP11173997

(51) Int. Cl. F03D 9/00

(52) U.S. Cl. 290/55

(57) ABSTRACT

The disclosure describes a wind turbine cooling arrangement including a passive heat exchanger arranged to absorb heat from a cooling circuit of a wind turbine, the passive heat exchanger is arranged on the exterior of the canopy to extend above a canopy of the wind turbine. The wind turbine cooling arrangement includes a ventilation arrangement which includes at least one air channel for channelling air onto a surface of the passive heat exchanger. Further described is a wind turbine including such a wind turbine cooling arrangement.

### CROSS REFERENCE TO RELATED APPLICATIONS

This application claims priority of European Patent Office application No. 11173997.5 EP filed Jul. 14, 2011. All of the applications are incorporated by reference herein in their entirety.

### FIELD OF INVENTION

A wind turbine cooling arrangement and a wind turbine comprising such a cooling arrangement are disclosed.

### BACKGROUND OF INVENTION

During operation of a wind turbine, heat is generated in various components, for example in the field of an electrical machine, in a converter, etc. This heat must somehow be dissipated in order to prevent overheating and heat-damage of the wind turbine components. Therefore, a wind turbine generally also comprises a cooling circuit. Such a cooling circuit may, for example, comprise heat-exchanging modules located close to the source(s) of heat, and these in turn are connected to an arrangement of pipes or tubes in which a coolant or heat transfer fluid circulates. In this way, heat may effectively be transferred from the hot components to the coolant in the cooling circuit. The warmed heat transfer fluid must then also be cooled in order for the cooling circuit to function effectively. Therefore, some way of dissipating the heat from the cooling circuit to the ambient surroundings is also usually necessary, particularly for large generators in which high temperatures may be reached during normal operation. For example, cool air may be directed to pass over conduits or heat exchangers of the cooling circuit, and the warmed air may be extracted or pumped out. However, since heat is essentially always generated by components of a wind turbine, even if the rotor blades are not turning, so that energy is essentially always required to power active cooling components such as pumps, compressors, ventilators etc. Furthermore, such active cooling is associated with costly machinery such as pumps and compressors that also require maintenance on a regular basis, since an efficient cooling is of paramount importance in a wind turbine.

A solution is known in which a cooling circuit in the interior of the nacelle or canopy is fed into a passive heat exchanger panel located on the exterior of the canopy. The panel is exposed to air and wind, which has the effect of cooling the cooling fluid, which may circulate in conduits or pipes arranged in the panel. Such a panel generally comprises a plurality of fins arranged with gaps in between to allow air to effectively pass through the panel, covering a relatively large surface area given by the fins. Evidently, the cooling capacity of such a panel is directly related to its size. A large wind turbine, for example a turbine with a capacity in the region of 5 MW, would require a correspondingly large panel. However, optimal cooling may be achieved only if the panel extends above the canopy, since the cooling effect of the wind is greatest there. Any part of the panel extending below the canopy or horizontally outward from the canopy would not be sufficiently exposed to air or wind, since those region are effectively screened from the wind, by the canopy itself or by the tower supporting the canopy. Therefore, the only really effective location for the panel is above the canopy. Another reason for having the panel on the outside of the canopy is for ease of maintenance. However, wind turbines in wind parks, particularly in offshore locations, are serviced by maintenance workers transported to the canopy by helicopter. Therefore, a platform is mounted on the top of the canopy so that the workers may safely by lowered or lifted. Safety regulations of the aviation authorities place limits on the height of any object with a certain range of the platform. For example, European aviation authorities specify a maximum height of 1.5 m for objects near the platform. Therefore, the panel of a passive heat exchanger cannot exceed 1.5 m when arranged close to such a platform. However, this height directly limits the cooling capacity, since the passive heat exchanger cannot, for practical reasons, be extended sideways beyond to the sides of the canopy or downwards below the canopy.

### SUMMARY OF INVENTION

It is an object to provide an improved cooling arrangement.

According to the invention, the wind turbine cooling arrangement comprises a passive heat exchanger arranged to absorb heat from a cooling circuit of a wind turbine, which passive heat exchanger is arranged on the exterior of the canopy to extend above the canopy; and a ventilation arrangement, which ventilation arrangement comprises at least one air channel for channelling air onto a surface of the passive heat exchanger.

The cooling arrangement may provide that the cooling capacity of the passive heat exchanger may easily be increased without having to increase its dimensions. An additional active cooling of the heat transfer fluid in the cooling circuit is not required in the interior of the canopy, so that expense may be spared. Instead, by directing more air at the surface of the passive heat exchanger, the cooling capacity of the cooling arrangement may be boosted or increased to a satisfactory level. Therefore, the cooling arrangement provides a solution that may provide sufficient cooling capacity by augmenting passive cooling with channelled air, while also allowing height regulations to be complied with, since the height of the passive heat exchanger need not be increased. Furthermore, the solution is particularly economical and cost-effective to carry out, since the ventilation arrangement may be realised in a straightforward manner., a wind turbine comprises such a wind turbine cooling arrangement.

Embodiments and features are given by the dependent claims, as revealed in the following description. Features described in the context of one claim category may apply equally to another claim category. Features of the different claim categories may be combined as appropriate to arrive at further embodiments.

The ventilation system may comprise an air channel mounted onto the exterior of the canopy. Such an air channel could be, for example, a flexible pipe or tube open at both ends and arranged such that air flows into the tube and exits onto the passive heat exchanger. A channel may also comprise a number of openings in a surface, for example the openings in a mesh- or grid-like panel arranged on the canopy. In this way, the cooling capacity of an existing passive cooling arrangement could be increased in a simple manner. However, an external air channel might be subject to weather damage over time. Therefore, in a embodiment, the air channel is arranged in the interior of the canopy, in the manner of a ‘tunnel’, and comprises an inlet arranged on a surface of the canopy for drawing in air, and an outlet for expelling the channelled air. This outlet may be arranged to open onto the passive heat exchanger, while an inlet may be arranged on a longitudinal surface of the canopy.

In an embodiment, the inlet of an air channel is arranged at a region of high pressure at the surface of the canopy, and an outlet of that air channel is arranged at a region of low pressure at the surface of the canopy. The outlet of an air channel may be wider than the main part of the channel and also wider than the inlet, so that the outlet end of a channel has a funnel shape. Furthermore, the outlets two or more air channels may be combined to obtain a larger outlet area. A flow of air through the channel may therefore be established in a purely passive manner, since air will be drawn or will move of its own accord through the open air channel from the region of relatively higher pressure at the inlet to the region of under-pressure or lower pressure at the outlet. The aerodynamic properties of the canopy are such that the air pressure behind the relatively blunt end of the canopy is considerably lower than the air pressure at the top or at the sides of the canopy. Therefore, with only minor additional design effort, a satisfactory airflow may be achieved through the air channel.

The outlet may be arranged in a posterior surface of the canopy. To allow the air to freely exit the air channel and to pass directly through the passive heat exchanger, the canopy may be designed so that the air channel outlet is close to the passive heat exchanger. In an embodiment, one or more outlets of the air channel(s) are arranged to open essentially directly onto the passive heat exchanger. To this end, any gap between the rear end of the canopy and the passive heat exchanger may be kept as small as possible, so that air exiting the air channel does not ‘escape’ through gaps between the sides of the canopy and the passive heat exchanger, and passes instead through the passive heat exchanger. The passive heat exchanger may be firmly secured to the canopy by struts or other connectors at appropriate points.

The air outlets of the channels may be arranged to open onto any appropriate portion of the passive heat exchanger. However, in an embodiment, the outlet(s) are arranged to direct a cooling airflow at a thermal transfer region of the passive heat exchanger, wherein a “thermal transfer region” is to be understood as a region in the vicinity of the entry point(s) of the hot transfer fluid into the heat exchanger, since such a region of the heat exchanger is warmest. In this way, by arranging the outlet of the air channel to open onto the hottest part or region of the passive heat exchanger, the cooling contribution of the ventilation system may be optimised, and the heat transfer fluid may be subject to a very effective cooling. The cooling effect of the airflow over the panel may then be sufficient to satisfactorily cool the heat transfer fluid.

Typically, the heat generated by the components in the wind turbine—generally referred to as ‘heat loss’—increases proportionally to the wind speed up to a certain threshold wind speed, beyond which the heat loss remains essentially constant. For instance, at low wind speed, the heat-generating components only generate relatively little heat. At speeds above the threshold wind speed, the cooling effect of the wind striking the panel and passing over it may be sufficient to cope with the maximum heat loss of the components. However, the cooling capacity of the passive heat exchanger described herein follows an essentially parabolic curve, as will be explained with the aid of the diagrams. Therefore, if a cooling arrangement (with a passive heat exchanger and one or more air channels) is to cover the cooling requirements of the wind turbine, there may be situations—for example at wind speeds below the threshold wind speed, and wind speeds above the threshold wind speed—in which the cooling capacity of the cooling arrangement is greater than actually required. On the other hand, if the excess cooling capacity is to be minimised, for example by using a smaller panel, the cooling capacity may not be sufficient to cope with the heat loss at wind speeds in the region of the threshold wind speed.

Therefore, in an embodiment, the ventilation arrangement comprises a ventilator or fan arranged in an air channel so that the airflow through that air channel may be favourably augmented or increased. By increasing the velocity of the air that exits the outlet of the air channel and passes over the panel, the cooling effect of the airflow is increased.

At low wind speeds, or at wind speeds above the threshold wind speed, the cooling effect of the panel and the unassisted airflow through the air channels may be sufficient to provide enough cooling. Therefore, in a further embodiment, the ventilator is activated according to an operational parameter, for example wind speed, rotor speed of the wind turbine, so that the cooling effect of the fan may be activated as required. Generally, a wind turbine is equipped with a wind speed sensor and/or a rotor speed sensor. The output value of such a sensor could be used to control the fan. For example, a fan could be turned on at a wind speed greater than a predefined minimum wind speed, and turned off again for wind speeds exceeding a predefined maximum wind speed. Alternatively, the ventilator could be controlled dynamically, for example by gradually increasing the speed of rotation of the fan as the wind speed increases towards the threshold wind speed, and by gradually decreasing the speed of rotation of the fan as the wind speed increases beyond the threshold wind speed. Such a fan or ventilator could be realised as a frequency controlled ventilator. Of course, the same control approach applies for decreasing wind speeds, in which case the ventilator is activated or dynamically controlled to cope with the increased cooling requirements as the wind speed drops.

To provide an even and thorough cooling of the panel, the ventilation arrangement in the cooling arrangement may comprise at least two channels. In a arrangement, the cooling arrangement comprises two air channels realised as interior ‘tunnels’ in the canopy and with inlets arranged one on each side of the canopy, for example one on each side of a heli-hoist platform. A ventilator or fan may be arranged in one or both air channels.

To obtain an optimum cooling, the passive heat exchanger and the ventilation arrangement are dimensioned such that a cooling capacity of the passive heat exchanger is less than a maximum heat loss of the wind turbine, and the ventilation arrangement is dimensioned such that a cooling capacity of the cooling arrangement matches or exceeds a maximum heat loss of the wind turbine. For example, the dimensions of the panel may be kept favourably compact, so that the cooling effect of the wind is sufficient to provide the required cooling at relatively low and relatively high wind speeds. For intermediate wind speeds and higher heat loss, the air channels may be dimensioned to provide an effective airflow, and the outlets may be arranged to direct the air at the critical or warmest parts of the panel. Outlets of two or more air channels may be combined to obtain a larger outlet area. Furthermore, any ventilators or fans may be chosen to efficiently draw air into the channels and to expel the channelled air onto the panel.

The cooling circuit may be arranged to absorb heat generated by components in the interior of the wind turbine, and heat transfer fluid is transported in conduits or pipes in the interior of the passive heat exchanger. In an embodiment, the passive heat exchanger or panel comprises a housing, which housing supports a heat dissipating structure arranged to absorb heat from the cooling circuit of a wind turbine. For example, the heat dissipating structure may comprise an arrangement of vertical fins separated by gaps through which air may pass. Conduits entering the panel may be arranged to pass close by the base of the fins, so that the heat transfer fluid, moving through the conduits, may effectively transfer heat to the fins. In a further embodiment, pipes or conduits transporting heat transfer fluid could be arranged to travel through the fins, so that an additional cooling effect could be achieved.

An embodiment of the material of the passive heat exchanger is light and robust, and acts as a good conductor of heat. For example, a favourable choice of material might be aluminium.

To allow the cooling arrangement to be incorporated in a wind turbine that is to be serviced by workers transported by helicopter to the wind turbine, the passive heat exchanger may extend above the canopy of the wind turbine to a height that satisfies a maximum regulation height defined by a relevant aviation authority. In order to incorporate the cooling arrangement in a wind turbine in a European region, the passive heat exchanger may extends above the canopy of the wind turbine to a height of at most 1.5 m.

A wind turbine may comprise a platform or heli-hoist platform arranged on an upper side of the canopy, and the platform is dimensioned to take into account the geometry of the passive heat exchanger. For example, the platform may be dimensioned to be at most as wide as the passive heat exchanger, and to deflect little or no air away from the panel, so that the cooling capacity of the panel is not reduced, or is not significantly reduced, by the presence of the platform.

A wind turbine may comprises a cooling arrangement with two air channels arranged in the interior of the canopy such that the inlets of the channels are arranged one on either side of a platform such that the air intake of the channels is not obstructed.

### BRIEF DESCRIPTION OF THE DRAWINGS

Other objects and features of the present invention will become apparent from the following detailed descriptions considered in conjunction with the accompanying drawings. It is to be understood, however, that the drawings are designed solely for the purposes of illustration and not as a definition of the limits.

FIG. 1 shows a schematic representation of a wind turbine with a first type of prior art cooling arrangement;

FIG. 2 shows a schematic representation of a wind turbine with a second type of prior art cooling arrangement;

FIG. 3 shows a schematic representation of a wind turbine with a cooling arrangement according to a first embodiment;

FIG. 4 shows a schematic representation of a wind turbine with a cooling arrangement according to a second embodiment;

FIG. 5 shows a schematic representation of a wind turbine with a cooling arrangement according to a third embodiment;

FIG. 6 shows a schematic representation of a wind turbine with a cooling arrangement according to a fourth embodiment;

FIG. 7 shows a graph of cooling capacity and heat loss;

FIG. 8 shows a graph of heat loss and cooling capacity of the hybrid cooling arrangement of FIG. 5.

### DETAILED DESCRIPTION OF INVENTION

In the drawings, like reference numbers refer to like objects throughout. Objects in the diagrams are not necessarily drawn to scale.

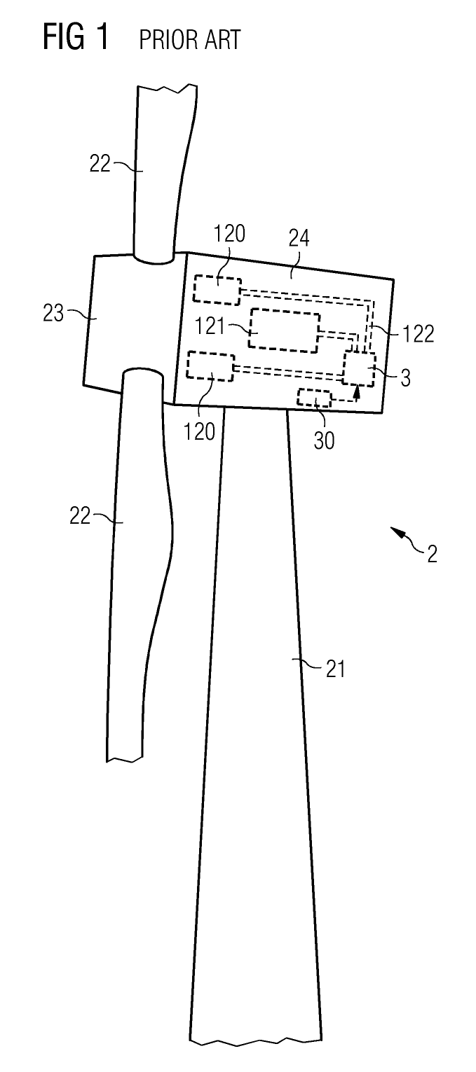

FIG. 1 shows a schematic representation of a wind turbine 2 with a first type of prior art cooling arrangement 122, 3 in the interior of a canopy 24 mounted on a tower 21. During operation of the wind turbine 2, rotor blades 22 cause the hub 23 to rotate, so that an electrical machine in the interior of the canopy is caused to generate electricity. Heat is generated during operation of the wind turbine 2, for example in components 120 or modules 120 of the electrical machine, in a power converter 121, etc. Here, only a few such heat sources 120, 121 are indicated, but it will be clear to the skilled person that heat may be generated by other components also. To cool these components 120, 121, a heat transfer fluid may be pumped through suitably placed conduits 122 or pipes 122, and the heat transfer fluid may be cooled in an active heat exchanger unit 3 using techniques known in the field of refrigeration. The active heat exchanger unit 3 requires an appropriate power supply 30. Evidently, such a power supply 30 is associated with certain running costs. Furthermore, as mentioned in the introduction, such an active heat exchanger unit 3 may be costly to manufacture and maintain.

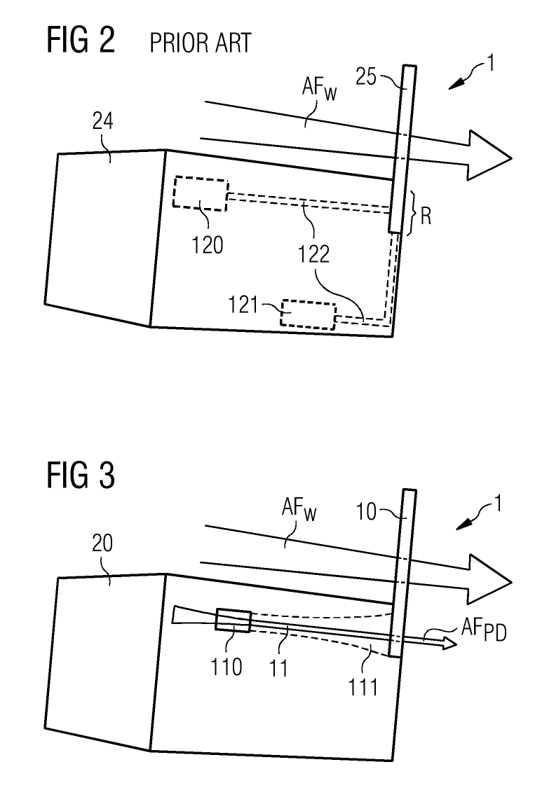

FIG. 2 shows a schematic representation of the canopy 24 of a wind turbine 2 with a second type of prior art cooling arrangement 122, 25. Here, heat generated by the heat-generating components 120, 121 of the wind turbine 2 is transferred to a heat transfer fluid in conduits 122 or pipes 122, and directed to a passive heat exchanger 25 mounted on the exterior of the canopy 24. A heat dissipating structure of the heat exchanger, for example an arrangement of vertical fins with intervening spaces or gaps, is heated at the hottest region R in which the conduits 122 enter the heat exchanger. Such a passive heat exchanger 25 generally comprises a housing supporting a plurality of heat-dissipating fins, and the conduits 122 may extend into the heat exchanger 25 and may be arranged to effectively transfer heat to the base of the fins, as will be clear to the skilled person. The passive heat exchanger 25 presents a relatively large surface area to the wind AF_{W} or airflow AF_{W} passing over the canopy 24 and through the heat exchanger 25. However, the cooling capacity of the passive heat exchanger 25 is limited by its size. Therefore, to cool a large wind turbine at all wind speeds, even around the critical threshold wind speed, the passive heat exchanger 25 would have to be correspondingly large. However, for the reasons given above, a too large passive heat exchanger 25 is impracticable, and very strong winds might even damage it. Therefore, depending on the wind turbine construction, this type of passive heat exchanger 25 with its limited surface area might not be able to provide the necessary cooling during wind speeds around the threshold wind speed.

FIG. 3 shows a schematic representation of the canopy 20 of a wind turbine 2 with a cooling arrangement 1 according to a first embodiment. For simplicity, the heat-generating components and the conduits for a heat transfer fluid are not shown, but may be assumed to be as shown in FIG. 2 above. Here, the cooling capacity of a passive heat exchanger 10 is augmented by an additional cooling means or ventilation means, in this case, an air channel 11 arranged in the interior of the canopy 20, with an air inlet 110 on the side of the canopy 20, and an air outlet 111 arranged to open onto the passive heat exchanger 20. The air channel 11 with its air inlet 110 and air outlet 111 is arranged to make use of the pressure difference in air pressure at different regions about the canopy, so that the air pressure at the air outlet 111 is lower than at the air inlet 110. The air outlet 111 is arranged to open directly onto the heat exchanger 10. In this way, airflow AF_{PD} is effectively drawn of its own accord, owing to the under-pressure at the channel outlets 111, through the air channel 11 and onwards through openings between fins of the heat exchanger 10. At wind speeds about the critical threshold wind speed, i.e. at times when the cooling requirements are greatest, the contribution of the additional air cooling provided by the airflow AF_{PD} through the air channel 11 and onto the panel 10 may be enough to ensure that the total cooling capacity of the cooling arrangement 1 is sufficient to cope with the maximum heat generated by the wind turbine components.

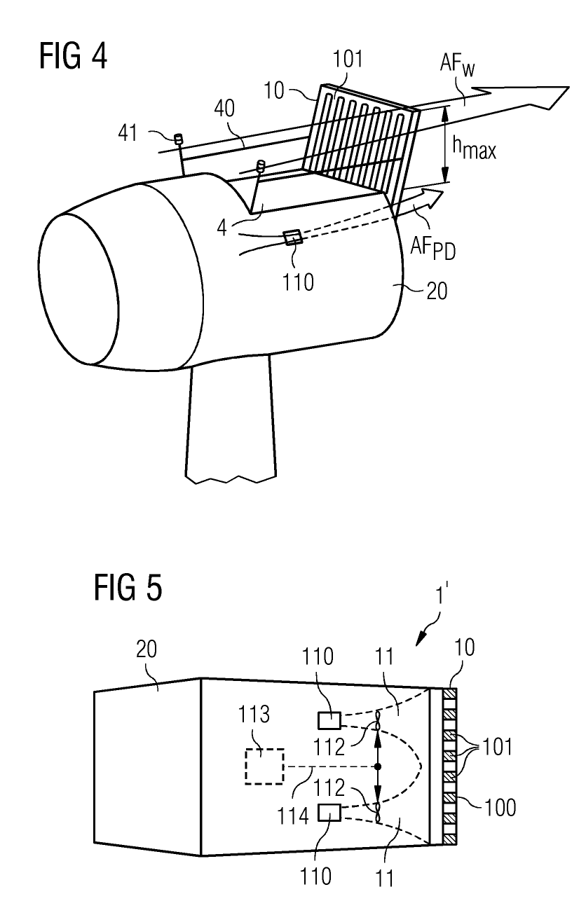

FIG. 4 shows a schematic representation of the canopy 20 of a wind turbine 2 with a cooling arrangement according to a second embodiment. This diagram also shows the fins 101 of the heat exchanger 10. Here, the passive heat exchanger 10 or panel 10 is mounted on the canopy 20 in such a way that it forms part of a heli-hoist platform 4 on top of the canopy 20. The height of the panel 10 in this embodiment does not exceed 1.5 m above the height of the platform floor, since 1.5 m is the maximum allowable height according to the European aviation authorities. A helicopter may therefore safely hover above the platform while maintenance workers are lowered to or lifted from the platform 4, for example by means of a motorised winch in the helicopter. Any railings 40 or safety features such as warning lights 41 may be arranged to avoid any obstruction of an airflow AF_{W} over the panel 10.

FIG. 5 shows a schematic representation of a wind turbine 2 with a cooling arrangement 1 according to a third embodiment. Here, the canopy 20, passive heat exchanger 10 and inlets 110 are shown from above. The cross-sectional view of the passive heat exchanger 10 schematically indicates a heat dissipating structure 101 arranged within a housing 100, for example an aluminium housing 100, with a plurality of vertical fins 101 separated by intervening spaces to maximise the area of the heat-dissipating structure 101. In this embodiment, two air channels 11 are arranged within the canopy 20. The diagram also shows a possible shape for the air channels 11, in this case, the air inlets 110 are positioned to either side of a highest part of the canopy 20, and the air outlets 111 are relatively wide, flaring towards the ends of the channels 11 to give a combined opening onto the base of the passive heat exchanger 10. Again, the air outlets 111 are arranged to open directly onto the hottest part of the heat exchanger 10. The air channels 11 may open onto a part of the panel in which the conduits, transporting warm heat transfer fluid, enter the panel, for example at a lower region of the passive heat exchanger 10. In the case where the cooling capacity of the passive heat exchanger 10 augmented by an airflow AF_{PD} (arising on account of a pressure difference between the inlets 110 and the outlets 111 or an under-pressure at the outlets 111) is insufficient to cope with the heat given off by the wind turbine components, the cooling capacity of the cooling arrangement 1 may be augmented further by activating ventilators 112 arranged in the air channels 11 to generate an increased airflow AF_{FAN} may be generated. The ventilators 112 may be activated by a signal 114 provided from a sensor 113, for example a wind speed sensor 113. At peak times, therefore, the cooling capacity of this hybrid cooling arrangement 1, using wind airflow AF_{W} and augmented channel airflow AF_{FAN} may reliably cool the heat transfer fluid of the cooling circuit to ensure optimal and sufficient cooling for the heat-generating components of the wind turbine.

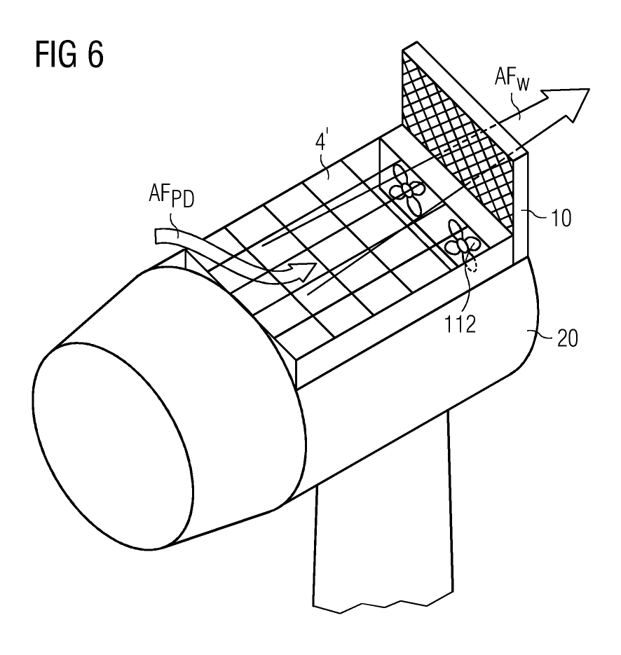

FIG. 6 shows a schematic representation of the canopy 20 of a wind turbine 2 with a cooling arrangement 1 according to a fourth embodiment. Again, the passive heat exchanger 10 or panel 10 is mounted on the canopy 20 in such a way that it forms part of a heli-hoist platform 4′ on top of the canopy 20. However, in this realisation, the heli-hoist platform 4′ comprises a robust mesh 4′ or grid 4′ with many openings or holes to allow air to pass from above the canopy to a space underneath the platform 4′, providing an additional cooling airflow AF_{PD}. In this embodiment, ventilators 112 are also positioned in the space beneath the platform 4′, and may be used to generate an increased airflow as required.

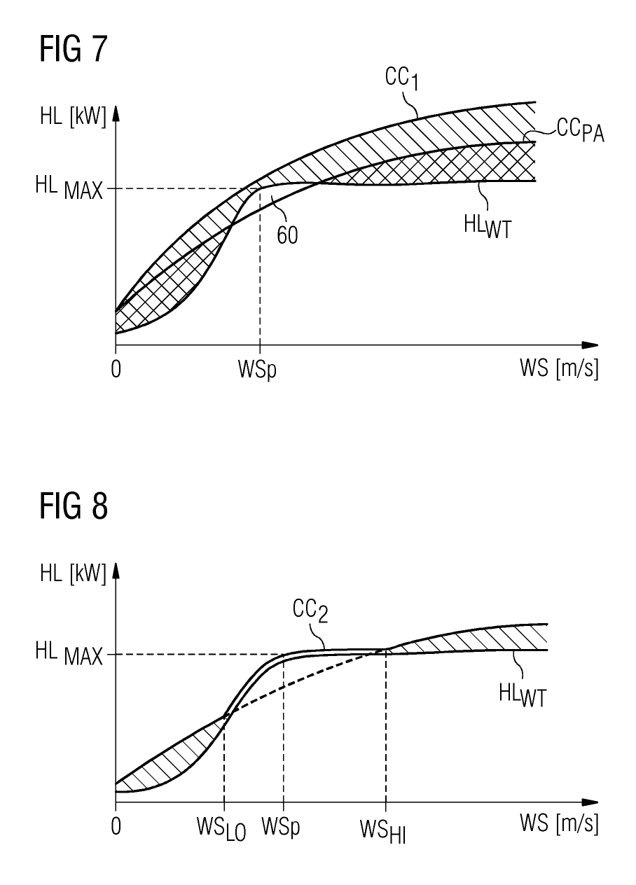

FIG. 7 shows graphs of the cooling capacity CC_{PA} of a prior art passive heat exchanger shown in FIG. 2, the cooling capacity CC₁ of a cooling arrangement according to the embodiment described in FIG. 3, and the heat loss HL (in kW) of the components of the wind turbine as a function of wind speed WS (in m/s). The maximum heat loss HL_{MAX} depends of a wind turbine depends on various factors, for example the wind turbine dimensions, the efficiency of the electric machine, reactive power mode of the converter, etc. The graph shows a wind turbine heat loss curve HL_{WT}. As the wind speed increases from 0 m/s, the heat loss of the wind turbine increases steadily, up to a certain maximum value HL_{MAX}. Beyond a certain wind speed WS_{TH}, the heat loss remains more or less at this maximum HL_{MAX}. The cooling capacity of a cooling arrangement using a passive heat exchanger, as described in FIGS. 2 and 3 above, follows an essentially parabolic curve CC_{PA}, CC₁. The steepness of this curve will depend on the area of the passive heat exchanger. As indicated by the curve CC_{PA}, the cooling capacity of a prior art passive heat exchanger that is not large enough is insufficient to cope with the peak cooling requirements. This ‘insufficiency’ is indicated by the intersection 60 of the first curve CC_{PA} and the heat loss curve HL_{WT}. Even so, to the left and right of the threshold wind speed WS_{TH}, the passive heat exchanger has wasted cooling capacity. A larger passive heat exchanger might be able to provide sufficient cooling, but its physical dimensions would be impracticable for the reasons given above, and such a physically large design would be associated with correspondingly higher levels of wasted cooling capacity.

A cooling arrangement, i.e. comprising a passive heat exchanger and a number of air channels for providing additional airflow AF_{PD} over the passive heat exchanger as described in FIG. 3 above, may provide sufficient cooling capacity, as indicated by the curve CC₁. The differences between the curves CC_{PA}, CC₁ may be attributed solely to the additional cooling effect of that additional airflow AF_{PD}. However, some cooling capacity of the cooling arrangement is also ‘wasted’ here, as indicated by the crosshatched regions between the cooling capacity curve CC₁ and the heat loss curve HL_{WT}.

FIG. 8 shows a graph of heat loss HL_{WT} (in kW) of the components of the wind turbine as a function of wind speed WS (in m/s) and a graph CC₂ of the cooling capacity of the hybrid cooling arrangement of FIG. 5, which uses both passive cooling and fan-augmented active cooling in a hybrid cooling arrangement. The hybrid cooling arrangement 1 of FIG. 5 is associated with less wasted cooling capacity, as indicated by the crosshatched regions. However, sufficient cooling of the wind turbine components is ensured by additional active cooling which may be applied whenever required. Here, beyond a certain first wind speed WS_{LO}, the active cooling is activated to cope with the peak cooling requirements, so that the ventilators in the air channels actively draw in air and direct it at the passive heat exchanger. This additional cooling may be maintained until the wind speed either drops below the first wind speed WS_{LO} again or increases beyond a second, higher, wind speed WS_{HI}, at which wind speed WS_{HI} the cooling capacity of the passive heat exchanger is again sufficient to cool the heat transfer fluid. With such a hybrid design, cooling is sufficient, even at wind speeds about the threshold wind speed WS_{TH}, while the dimensions of the passive heat exchanger may be kept within practicable limits.

Although the present invention has been disclosed in the form of embodiments and variations thereon, it will be understood that numerous additional modifications and variations could be made thereto without departing from the scope. For example, the passive heat exchanger could also comprise lateral elements that extend sideways away from the canopy to increase cooling capacity, whereby such lateral extensions may be are dimensioned so that these also comply with maximum allow height so that aviation regulations are complied with. Accordingly, the particular arrangements disclosed are meant to be illustrative only and not limiting as to the scope, which is to be given the full breadth of the appended claims, and any and all equivalents thereof.

For the sake of clarity, it is to be understood that the use of “a” or “an” throughout this application does not exclude a plurality, and “comprising” does not exclude other steps or elements. A “unit” or “module” may comprise a number of units or modules, unless otherwise stated.

1. A wind turbine cooling arrangement, comprising:
a passive heat exchanger arranged to absorb heat from a cooling circuit of a wind turbine, the passive heat exchanger is arranged to extend above a canopy of the wind turbine; and
a ventilation arrangement comprising an air channel that channels air onto a surface of the passive heat exchanger.

2. The wind turbine cooling arrangement according to claim 1,
wherein the air channel comprising an outlet that expels the channelled air, the outlet is arranged to open onto the passive heat exchanger.

3. The wind turbine cooling arrangement according to claim 1,
wherein the air channel comprising an inlet that draws in the channelled air, the inlet is arranged on a longitudinal surface of the canopy

4. The wind turbine cooling arrangement according to claim 3,
wherein the inlet of an air channel is arranged at a region of high pressure at the surface of the canopy, and
wherein an outlet of the air channel is arranged at a region of low pressure at the surface of the canopy.

5. The wind turbine cooling arrangement according to claim 1,
wherein the ventilation arrangement comprising a ventilator arranged in an air channel.

6. The wind turbine cooling arrangement according to claim 5,
wherein the ventilator is activated according to an operational parameter of the wind turbine.

7. The wind turbine cooling arrangement according to claim 1,
wherein the ventilation arrangement comprising at plurality of air channels.

8. The wind turbine cooling arrangement according to claim 1,
wherein the air channel is arranged in the interior of the canopy.

9. The wind turbine cooling arrangement according to claim 1,
wherein the passive heat exchanger is dimensioned such that a cooling capacity of the passive heat exchanger is less than a maximum heat loss of the wind turbine, and
wherein the ventilation arrangement is dimensioned such that a cooling capacity of the cooling arrangement matches or exceeds a maximum heat loss of the wind turbine.

10. The wind turbine cooling arrangement according to claim 1,
wherein the passive heat exchanger comprising a housing, which supports a heat dissipating structure arranged to absorb heat from the cooling circuit of a wind turbine.

11. The wind turbine cooling arrangement according to claim 2,
wherein an outlet of the air channel is arranged to open essentially directly onto the passive heat exchanger.

12. The wind turbine cooling arrangement according to claim 2,
wherein an outlet of the air channel is arranged to direct a cooling airflow at a thermal transfer region of the passive heat exchanger.

13. The wind turbine cooling arrangement according to claim 1,
wherein the passive heat exchanger extends above the canopy of the wind turbine to a height that satisfies a maximum regulation height, preferably to a height of at most 1.5 m.

14. A wind turbine, comprising:
a wind turbine cooling arrangement according to claim 1.

15. The wind turbine according to claim 14, comprising:
a platform arranged on an upper side of the canopy, and wherein the platform is dimensioned according to the passive heat exchanger.
